(19) United States
(12) Patent Application Publication
(10) Pub. No.: US 2022/0414613 A1
(43) Pub. Date: Dec. 29, 2022

(54) REMOTE MONITORING, TROUBLESHOOTING AND SERVICE SCHEDULING OF ANALYTICAL APPARATUSES

(71) Applicant: Thermo Finnigan LLC, (US)

(72) Inventors: Helene L. CARDASIS, Felton, CA (US); Ping F. YIP, Salem, MA (US); Jacob R. SCHWARTZ, Spokane Valley, WA (US); Stephen GNANASAMY, Cedar Park, TX (US); Adam F. Kimball, Boise, ID (US); Michael W. SENKO, Sunnyvale, CA (US); Vladimir ZABROUSKOV, Belmont, CA (US)

(21) Appl. No.: 17/778,805

(22) PCT Filed: Nov. 24, 2020
(86) PCT No.: PCT/US2020/062092

§ 371 Date: May 20, 2022

Related U.S. Application Data
(60) Provisional application No. 62/940,783, filed on Nov. 26, 2019.
(60) Provisional application No. 63/049,990, filed on Jul. 9, 2020.

(51) Int. Cl. G06Q 10/00; G06N 3/02; G06N 5/02

(52) U.S. Cl. CPC G06Q 10/20; G06N 3/02; G06N 5/02

(57) ABSTRACT

A system comprises: (1) a central location comprising: (a) computer storage media having one or more databases thereon; and (b) one or more computers configured to communicate with the computer storage media: and (2) a plurality of sites, each site comprising: (a) an analytical apparatus; and (b) a site computer system comprising program instructions operable to generate a collection of apparatus signatures, each apparatus signature comprising a collection of data relating to the operation of the analytical apparatus at a time when said signature is generated, wherein the one or more computers at the central location are configured to store each collection of signatures in the one or more databases. In embodiments, each site computer system stores the plurality of apparatus signatures generated at the respective site and transmits the stored apparatus signatures to the one or more computers at the central location.

### TECHNICAL FIELD

The present disclosure relates to systems and methods for servicing and maintaining a plurality of analytical apparatuses or systems, including the, various instrumental sub-systems modules, components and individual parts contained therein. More particularly, the present disclosure relates to such systems and methods that are capable of identifying and predicting the root causes of actual or potential performance degradation of each of the plurality of analytical apparatuses.

### BACKGROUND

Generally, analytical systems (also referred to, herein, as analytical systems) can comprise of a plurality of parts or components, modules, and instruments. They provide either a determination of the identity or characterization of structure of one or more chemical compounds or substances in a sample, a qualitative determination as to whether one or more compounds are present in (or absent from) a sample and/or a quantitative determination of the relative or absolute amount(s) or concentrations of one or more compounds in a sample. As the complexity of analytical apparatuses increases (in either the number of underlying entities or complexity of individual underlying entities), the process of troubleshooting after unexpected problems arise becomes more difficult and more time consuming. According to a conventional instrument servicing and support procedure, instrument operators/owners place a service call to technical support personnel after a problem arises. They report their description of the problem, which generally include general symptoms and possibly their interpretation of the source of the problem. Without any data on the system or failure state, technical support is not equipped to triage calls to the proper service professional. As such, the call may be assigned to a service support engineer based on locality and availability. This specialist then travels to the instrument site and begins troubleshooting as per their sub-system training. Restoration of proper system performance could take hours to weeks, depending on whether the proper specialist was sent to the site and whether the proper diagnostic tests were run that isolated the problem correctly. This model of service depends heavily on the level of both operator/owner and service personnel training, experience, and proficiency.

The inconsistency and inefficiency of the conventional servicing and support model is unacceptable in the routine analysis and clinical markets. This leads to lengthy and unexpected instrument downtime, as well as potentially high costs to both the service vendor and the instrument operator as a result of on-site trial and error troubleshooting. With the development of systems earmarked as medical devices and clinical or routine applications underway, improving this conventional procedure of instrument servicing is critical.

Many complex analytical apparatuses/systems contain many interacting components/parts, modules, and/or instruments. Failure of any one component, module, or instrument can lead to a system failure. The manifestations of such system failure can be generic and non-diagnostic by themselves. Additionally, some failure modes are characterized not by the binary failure of one component, module, or instrument, but by subtle coordinated changes in a number of variables that lead to system performance decline. Without an understanding of how each component, module, or individual instrument is behaving, diagnosing the root cause of a system failure is time consuming and inefficient. Currently, some analytical instruments or modules include control software that is able to record a number of diagnostic tests and evaluations that may be used later for post-failure troubleshooting in accordance with the conventional servicing and support model. The control software of such instruments or modules may also be configured to record various “status” metrics (pressures, temperatures, voltages, etc) on each system at regular frequencies, as well as system settings. However, according to the conventional model, this information is not collected or saved in a sufficiently comprehensive manner by which it could be properly collected from all components, modules, or instruments in the system, and thus correlated or analyzed together, as a whole. Because of the complexity of most modern analytical apparatuses, one should examine each entire apparatus as a system instead of examining the system instrument by instrument, module by module, and measurement by measurement.

### SUMMARY

The teachings of the present disclosure aim to address the issue of inefficient and ineffective analytical instrument support according to the conventional servicing and support model. Systems and methods in accordance with the present teachings may use standardized terminologies to communicate and relate data from different types of analytical instruments in a web of interconnected data that serves as knowledge from which operational and/or functional trends may be inferred, future events may be predicted and new insights may be discovered and acted upon. The present teachings include modifications to the way both hardware metrics and application-specific performance metrics are collected and stored. In accordance with the present teachings, such information is structured as a whole system “signature” such that it can be regularly generated, stored, and encrypted locally at each instrument site. The general approach is to augment and enhance operational and/or functional information that is available locally within an analytical instrument and to organize the resulting collection of data into a context that is diagnostically relevant.

Each signature comprises a plurality of fields or entries, each of which conveys information regarding a particular aspect of the state of a particular analytical instrument. The content of each field in each signature (both in definition and statistics) is defined, for each class or type of analytical apparatus or system, by the manufacturer to ensure the relevancy and significance of each field in the signature. Preferably, the signature includes, in addition to readings recorded by on-board sensors, various contextual information such as configuration information, settings, records of errors and other events, usage statistics, and consumables usage. The format of the signature is preferably designed such that it is flexible, adaptable to future hardware changes, small in size (kBytes), and consistent between all hardware platforms provided by a particular vendor. Because the signature is compiled locally (at the site of the apparatus or system to which it pertains), it can be transferred to a remote location for organization into time series and analysis. The information is encrypted, prior to transfer, in a manner that is acceptable to even the most privacy-conscious users, such as those users who work in the medical and health care fields.

From a diagnostic or prognostic standpoint, the benefit of linking hardware and performance metrics from all subsystems of an analytical system into one full system signature is that these very different but related metrics provide context to one another. Instead of relying on the diagnostic value of each metric, one at a time, the provision of a whole-system signature in accordance with the present teachings enables technical personnel to be able to observe subtle changes to the system as a whole. As a result, through correlation of the metrics that have changed or are changing at the same time, service personnel can holistically predict the root cause of system failure, or determine sub-systems that will require preventative action to avoid failure.

By converting conventional specific on-demand, post-failure diagnostic tests into regular, scheduled evaluations and normalizing the recording of all status information to a frequency and statistical representation that provides diagnostic value, it is possible to record signatures that are associated with normal hardware performance. Through data analysis, such nominal signatures may be contrasted to signatures that are associated with reduced performance, errors and instrument breakdowns. The hardware-based fields of a particular signature can then be linked to other fields pertaining to application-specific performance metrics that are derived from running defined quality control samples and methods. The hardware-based fields include status information relating to measured instrumental variables which may include, without limitation, voltages measured at various test points, temperatures and pressures measured at various locations, measured ion beam or electron beam intensity, measured light source luminance, laser power, event occurrence, configuration data, utilization data, etc. The coupling of hardware-related and performance-related fields, such performance-related fields created either automatically or manually, is used to create a plurality of information-rich full-system signatures.

Each full-system signature is constructed from a plurality of signature items, where each item is a specific measurement relating to a particular system variable, operational parameter or event. Additionally or alternatively, each signature item may relate to a variable, operational parameter or event associated with a part, component, module or instrument. These variables may possibly be measured at different respective frequencies. By collecting the various signature items, full-system signatures may be constructed, where each variable corresponds to a specific data field or entry in the signature. Data interpolation, as guided by data propagation rules, allows each such full-system signature (hereinafter, referred to as simply a “signature”) to correspond to a particular time point.

By collecting the signatures from each instrument over time, generally at a central location having computing and database resources, one can populate a database and subsequently mine this data to develop a diagnostic or predictive model of platform failure. Data-mining techniques that employ artificial intelligence software are then used to develop a classifier for each instrument or instrument class that provides maximum accuracy in both diagnosing and predicting failures. Such capabilities comprise the foundation for remote monitoring, remote service-call triage, remote troubleshooting and, in turn, reduced time and cost per service call, and a significant reduction in unexpected downtime though preventative maintenance scheduling.

Signature data may be provided in any computer-readable structured data format. Preferably, however, the signature data is provided in a format that employs defined categories, properties, concepts, relations and entity definitions in accordance with one or more standard ontologies (sometimes known as “knowledge graphs”), as used in information science. Because data may be compiled from a plurality of different analytical instruments, it is desirable that all instruments use a common vocabulary that can enable consolidation of the data from multiple instruments and subsequent formulation of conclusions based on the consolidated data. A standard syntax may be used to communicate information that adheres to the standard vocabulary. Preferably, the syntax is standardized and is both computer-readable and human-readable. As examples, the JavaScript Object Notation (JSON) syntax or JavaScript Object Notation for Linked Data (JSON-LD) syntax may be employed.

Many ontology frameworks are available for adaptation and use with the present teachings. For example, the “Sensor, Observation, Sample, and Actuator” (SOSA) ontologies have been developed by the World Wide Web Consortium (W3C) to provide flexible but coherent perspectives for representing the entities, relations, and activities involved in sensing, sampling and actuation. The “Simple Knowledge Organization System” (SKOS), also developed by W3C, is another standard way to represent knowledge organization systems. So-called “OWL-Time”, also developed by W3C, is used to describe the temporal properties and temporal ordering relationships of any resource denoted using a web identifier (URI), including web-pages and real-world things. Ontologies from QUDT.org, the Allotrope Foundation™ (www.allotrope.org) and many other organizations are also available. These ontologies relate to units and measures (QUDT), analytical data and instrumentation (Allotrope), standard taxonomies (SKOS), and time (OWL-Time).

The developers of the various ontologies may be described as domain specialists. In accordance with the present teachings, various conceptual models are imported from the domain specialists as necessary. In this way, common terminology may be used to describe the very different systems that are inter-networked in accordance with the present teachings. This enables service or support personnel and artificial intelligence algorithms to make sense of and analyze new data from both existing instruments and new instruments and/or from a diverse set of instruments without having to decode the data stream of each particular instrument.

The present teachings include a system diagnostic classifier for each apparatus or system or for each class of apparatus or system. In order to analyze system signatures in an automated manner, a database of system signatures is required. By routinely collecting system signatures from many systems of the same class over time, it is possible to build and train a classifier that will automatically predict the root cause of a problem from a new previously “unknown” signature. Such a capability can allow service departments to quickly and automatically triage each service call in order to ensure that the appropriate service support specialist or engineer is sent on-site to address the problem and that this specialist or engineer arrives with the right parts required to solve the problem. For users that cannot afford or accept unexpected instrument downtime, regular collection and analysis of the system signatures can enable predictive analysis and preemptive action when performance is declining, thereby converting unexpected service calls to planned preventative maintenance visits. Collectively, and across all apparatus and system platforms, this would represent a major improvement to the quality and timeliness of product support.

The building of each classifier will start with the database of historical data. Domain experts can analyze signature data from a failing system and intelligently confirm the cause of a system failure. The determined failure modes can be used to annotate the system signature. These annotated signatures are then fed into the dataset to “train” the classifier. Over time, accumulating sufficient exemplars of various failure modes or categories will enable meaningful training of a classifier. This feedback loop of automation and expert on-site determination will further drive the classifier to more specific and accurate fault diagnosis. There exists a multitude of classification techniques that may be employed, from simple decision trees, to expert systems, to deep learning using an artificial neural network. The advantages of such a networked system; including whole-system signatures, signature-reporting infrastructure, database, computing resources and classifiers; include reduction in warranty period costs, accuracy of part failure reporting and, in, turn, inventory stocking, improved product design and overall improvement in the efficiency of instrument servicing and maintenance.

In accordance with a first aspect of the present teachings, a system comprises: (1) a central location comprising: (a) computer storage media having one or more databases thereon; and (b) one or more computers configured to communicate with the computer storage media; and (2) a plurality of sites, each site comprising: (a) an analytical apparatus; and (b) a site computer system comprising program instructions operable to generate a collection of apparatus signatures, each apparatus signature comprising a collection of data relating to the operation of the analytical apparatus at a time when said signature is generated, wherein the one or more computers at the central location are configured to store each collection of signatures in the one or more databases.

In accordance with a second aspect of the present teachings, a method comprises: (a) generating, at each one of a plurality of analytical apparatuses, each analytical apparatus being disposed at a respective site, a collection of apparatus signatures, each apparatus signature comprising a collection of data relating to the operation of the analytical apparatus at a time at which the said signature is generated; (b) transmitting each collection of apparatus signatures corresponding to an analytical apparatus from the respective site of the respective analytical apparatus to a database at a central location; (c) annotating at least a portion of at least one collection of apparatus signatures with information determined by service personnel in response to failures or reduced performance of one or more of the analytical apparatuses; (d) using computer-readable instructions that are operable to recognize trends in the signature data, performing a computer analysis of a collection of apparatus signatures having one or more annotations; and (e) generating, from the computer analysis, either a prediction of when the analytical apparatus corresponding to the collection of apparatus signatures will require calibration, component replacement, or other servicing or an identification of the root cause of a performance degradation of or failure of said analytical apparatus.

The teachings of the present disclosure also aim to address the issue of inefficient and ineffective conventional support for analytical instrument systems, such as hybrid analytical systems, that comprise more than one analytical instrument, possibly of different types, cooperatively working together with one another. For example, U.S. Pat. No. 10,088,460 teaches a system that includes a sample preparation system for preparing various samples and a sample analysis system, which includes a suitable analyzer, wherein the sample preparation system and the sample analysis system are commonly housed and are interconnected in an automated manner.

In accordance with some aspects of the present teachings, information communicated by an analytical instrument may be structured as a set of “signature” items that may be regularly generated, stored, and encrypted locally at each instrument site. The signature items record functional information that is available locally within an analytical instrument. By consolidating information from multiple signature items, possibly generated by multiple instruments or systems, the resulting collection of data is enhanced and organized into a context that is diagnostically and/or prognostically relevant.

Each signature item comprises a plurality of fields or entries, each of which conveys contextual information regarding a particular aspect of the state of a particular analytical instrument, or a subsystem, component module or individual part of the instrument. The content of each field in each signature item (both in definition and statistics) is defined, for each class or type of analytical instrument, module, component or part, by the manufacturer to ensure the relevancy and significance of each field in the signature item. Preferably, the signature includes, in addition to the reported measurement or record, various contextual information. Metric categories describe the type of data and contextual information that is contained in and reported by a particular type of signature item and further describe how such information should be propagated in time, when information from a plurality of individual signature items is later compiled into a “full system signature”. The various metric categories relate to various types of information pertaining to, for example, instrument configuration, activities, state changes, settings, records of errors and other events, usage statistics, and consumables usage. All signature items may include an evaluation of an “action category”, which may alert users, service personnel, research and development personnel or manufacturing personnel to a need to perform preventative maintenance, service call triage or other actions. Each action category evaluation applies to an individual signature item and indicates the relevant reaction to that data with requiring further processing. The format of the signature items is preferably designed such that it is flexible, adaptable to future hardware changes, small in size (kBytes), and consistent between all hardware platforms provided by a particular vendor.

The data available from signature item data can be linked together and/or compared with historical service records (each of which may comprise a symptom code, and/or one or more root cause codes) in order to annotate signature data patterns with failure classifications. By linking hardware metrics with performance metrics, or linking hardware metrics with service classifications into one full system signature, wherein the metrics are derived from all components, modules, and instruments of an analytical system the context of each of the various data points may be ascertained, both within and between each component, module, and instrument in the system. Instead of relying on the diagnostic value of each metric, one at a time, the provision of a whole-system signature in accordance with the present teachings enables technical personnel to be able to observe and understand subtle changes to the system as a whole. As a result, through correlation of the metrics that have changed or are changing at the same time across the system, service personnel, or an algorithm, can holistically predict the root cause of system failure or performance decline, or determine sub-systems that will require preventative action to avoid failure or repair.

In accordance with a another aspect of the present teachings, a method comprises: (a) generating, at each one of a plurality of analytical apparatuses, each analytical apparatus being disposed at a respective site, a collection of apparatus signatures items, each apparatus signature item comprising a collection of data relating to the function of the analytical apparatus at a time at which the said signature item is generated; (b) transmitting each collection of apparatus signature items from the respective site of the respective analytical apparatus to a database at a central location; and (c) generating a full-system signature of each one of a subset of the analytical apparatuses by combining information from a plurality of the signature items. In some instances, the method may further comprise (d) annotating at least a portion of the full-system signatures with information determined by service personnel in response to failures or reduced performance of one or more of the subset of analytical apparatuses. In some instances the method may yet further comprise the steps of: (e) using algorithms or computer-readable instructions that are operable to recognize trends in the signature data, performing a computer analysis of a collection of the full-system signatures having one or more annotations; and (f) generating, from the algorithmic or computer analysis, either a prediction of when an analytical apparatus will require calibration, maintenance, component replacement, or other servicing or an identification of the root cause of a performance degradation of or failure of said analytical apparatus.

### BRIEF DESCRIPTION OF THE DRAWINGS

The above noted and various other aspects of the present invention will become apparent from the following description which is given by way of example only and with reference to the accompanying drawings, not necessarily drawn to scale, in which:

FIG. 1 is a schematic illustration of a physical layout of a system for monitoring and maintaining optimal operation of a plurality of analytical apparatuses or analytical systems in accordance with the present teachings;

FIGS. 2A-2C are schematic demonstration of the use of a simple signature for discriminating between different respective root causes of a commonly observed type of reduced performance in a liquid-chromatography I mass spectrometry system;

FIG. 3A is a schematic depiction of updating of entries of a database of a system in accordance with the present teachings by a field technician or engineer, the updating comprising providing annotations relating to determined root causes of failure, or reduced performance and corrective actions taken in resolution of the problem;

FIG. 3B is a schematic depiction of generation of instrument-specific and/or instrument-class specific classifiers from instrument-specific signatures and annotations provided by a field technician or engineer;

FIG. 4 is a schematic depiction of hardware and software architecture of a system for monitoring, and maintaining, optimal operation of a plurality of analytical apparatuses or analytical systems in accordance with the present teachings;

FIGS. 5A-5C are schematic illustrations three different preferred methods for generating, analyzing and conveying data within a system in accordance with the present teachings;

FIG. 6 is a table of uses of information that may be derived from a consolidated database of historical apparatus data in accordance with the present teachings;

FIG. 7 is a table listing various categories of actions that may be indicated by the data that is collected in accordance with the present teachings;

FIG. 8 is a table of various metric categories of apparatus data that may be recorded in accordance with the present teachings;

FIG. 9 is a schematic depiction of two types of JSON-LD signature communications, as may be employed in accordance with methods and systems of the present teachings;

FIG. 10 is a listing of the various categories of information that may be communicated in signatures in accordance with the present teachings.

FIG. 11 is an example of a declarations signature item, as may be employed in apparatus communications in accordance with the present teachings;

FIG. 12 is an example of a listing of a signature item that marks the start and end of a process, as may be employed in apparatus communications in accordance with the present teachings;

FIG. 13 is an example of a listing of a signature item that records a change in the functional state of an apparatus, as may be employed in apparatus communications in accordance with the present teachings;

FIG. 14 is an example of a listing of a signature item that records an observation, as may be employed in apparatus communications in accordance with the present teachings;

FIG. 15 is an example of a listing of a signature item that records instrument settings, as may be employed in apparatus communications in accordance with the present teachings;

FIG. 16 is an example of a listing of a signature item that records results of an evaluation or diagnostic performed on the system or a component of the system, as may be employed in apparatus communications in accordance with the present teachings;

FIG. 17 is an example of a listing of a signature item that records the occurrence of an event, as may be employed in apparatus communications in accordance with the present teachings;

FIG. 18 is an example of a listing of a signature item that records usage statistics of various apparatus parts, as may be employed in apparatus communications in accordance with the present teachings;

FIG. 19 is an example of a listing of a signature item that records system usage statistics, as may be employed in apparatus communications in accordance with the present teachings; and

FIG. 20 is an example of a listing of a signature item that records usage statistics of various consumable items, as may be employed in apparatus communications in accordance with the present teachings.

### DETAILED DESCRIPTION

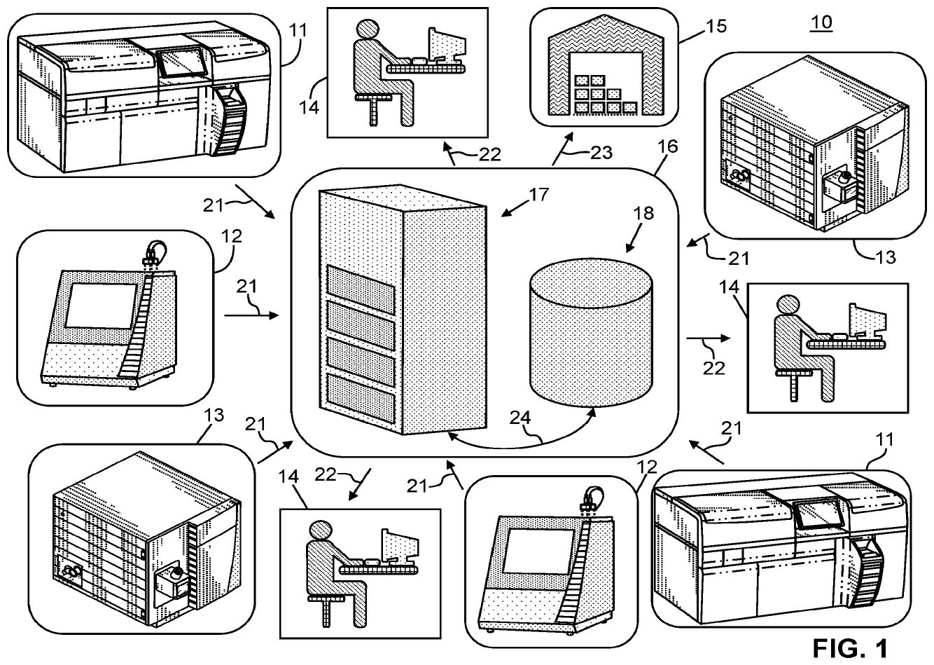

The following description is presented to enable any person skilled in the art to make and use the invention, and is provided in the context of a particular application and its requirements. Various modifications to the described embodiments will be readily apparent to those skilled in the art and the generic principles herein may be applied to other embodiments. Thus, the present invention is not intended to be limited to the embodiments and examples shown but is to be accorded the widest possible scope in accordance with the features and principles shown and described. To fully appreciate the features of the present invention in greater detail, please refer to FIGS. 1, 2A-2C, 3A-3B, 4 5A-5C and 6-20.

In the description of the invention herein, it is understood that a word appearing in the singular encompasses its plural counterpart, and a word appearing in the plural encompasses its singular counterpart, unless implicitly or explicitly understood or stated otherwise. Furthermore, it is understood that, for any given component or embodiment described herein, any of the possible candidates or alternatives listed for that component may generally be used individually or in combination with one another, unless implicitly or explicitly understood or stated otherwise. Moreover, it is to be appreciated that the figures, as shown herein, are not necessarily drawn to scale, wherein some of the elements may be drawn merely for clarity of the invention. Also, reference numerals may be repeated among the various figures to show corresponding or analogous elements. Additionally, it will be understood that any list of such candidates or alternatives is merely illustrative, not limiting, unless implicitly or explicitly understood or stated otherwise.

Unless otherwise defined, all other technical and scientific terms used herein have the meaning commonly understood by one of ordinary skill in the art to which this invention belongs. In case of conflict, the present specification, including definitions, will control. It will be appreciated that there is an implied “about” prior to the quantitative terms mentioned in the present description, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. As used herein, “a” or “an” also may refer to “at least one” or “one or more.” Also, the use of “or” is inclusive, such that the phrase “A or B” is true when “A” is true,

“B” is true, or both “A” and “B” are true. As used herein, the term “module” refers to a collection of computer readable instructions that is directed to enabling a computerized system to perform a specific function or set of functions.

FIG. 1 schematically depicts a general networked system 10, in accordance with the present teachings, for monitoring and maintaining optimal operation of a plurality of analytical apparatuses or analytical systems. Each of the various analytical apparatuses or systems is located in one of a plurality of laboratories, such as a hospital or other clinical laboratory, a corporate or university research laboratory, a testing laboratory of a governmental agency, etc. According to the present teachings, all such apparatuses report diagnostic data relating to the quality and history of instrument performance according to a common data format. Thus, the analytical apparatuses or systems may belong to one or more of various classes or types of apparatuses/systems, such as but not limited to mass spectrometers, liquid chromatographs, optical spectrometers (including fluorescence spectrometers, UV-visible spectrometers, Fourier-Transform infrared spectrometers, Raman spectrometers, transmittance spectrometers, reflection spectrometers, and optical absorbance spectrometers), scanning electron microscopes, transmission electron microscopes, X-Ray diffraction analyzers, X-Ray fluorescence analyzers, etc. For purposes of example, FIG. 1 depicts two instances of each one of three classes or types of apparatus/system. These include two instances of clinical mass spectrometers 11, two instances of liquid chromatographs 12 and two instances of stand-alone mass spectrometers 13.

Each analytical apparatus or system 11, 12, 13 comprises at least one local computer that comprises various software or firmware modules. A communications hub or module of each system (not shown in FIG. 1) is capable of reporting, over the Internet, instrument-specific signatures 21 relating to the quality and history of instrument performance (e.g., sensor measurements, operational parameters, events, etc.) to a common location 16. The common location 16 comprises at least one data storage module 18 for receiving and storing the instrument-specific signature 21 of each apparatus or system, one or more central computers, comprising server computers or other computers 17 for analyzing the received data and one or more channels 24 of two way communication between the at least one data storage module 18 and the one or more central computers 17. The common location 16 may comprise a data center (often referred to as “the cloud”) of the type that leases data storage space (storage-as-a service), computer access time (computing-as-a-service) and possibly access to software (software-as-a-service) to a variety of users for a variety of independent purposes. Alternatively, the common location may wholly under the control of a manufacturer or vendor of the analytical apparatuses or systems.

The one or more central computers 17 (FIG. 1) are capable of running specialized software that is capable of decoding the instrument-specific signature 21 of each apparatus or system, analyzing the data and identifying, from the analyses, any required calibrations or any apparatus/system components that either require immediate servicing or replacement. Preferably, the specialized software is also capable of predicting when certain apparatuses or systems will require calibration or other servicing or component replacement. The specialized software is further configured to provide notifications 22 to service personnel 14 to notify such personnel of any requirements to travel to instrument sites to perform required calibrations or servicing. The specialized software may be further operable to perform one or more of: scheduling service visits to optimize efficiency, notifying the service personnel 14 of any special tools or components that will be required at the time of their service visits and sending notifications 23 to factories or warehouses 15 to ship required components to sites requiring service visits in advance of the arrival of service personnel.

The instrument-specific signature 21 from each analytical apparatus or system 11, 12, 13 is sent in an encrypted form to the common location 16 in order to preserve data confidentiality and user privacy. The instrument-specific signature 21 may include, without limitation: (a) the time and date of signature recordation and/or transmission; (b) unique instrument identification information; (c) instrument-specific configuration information; (d) status information relating to measured instrumental variables (e.g., voltages at various test points, temperatures and pressures measured at various locations, ion beam or electron beam intensity, light source luminance, laser power, etc.); (d) usage statistics; (e) instrument settings; (f) calibration settings; and (f) results from recent scheduled evaluations or diagnostics; (g) results from recent system suitability-related measurements of standard samples; (h) consumables availability and consumption; (i) serial numbers of the apparatus and, if available, of components; (j) part numbers of components; (k) version and/or revision numbers of software and firmware, etc.

The exact information that is included within the instrument-specific signature 21 is dependent on the class of analytical apparatus to which the data pertains. Such data is stored locally in an event-driven manner, and transmitted to the common location 16 at a frequency that may be determined by the user(s). The data pertaining to measured instrumental variables may be provided as a single average value for each variable, together with a statistical measure of variation, as determined from all measurements of the respective variable made since a prior recording of that signature item.

Alternatively, the data may comprise the raw measurements, without pre-processing.

As a further alternative, the status of each instrumental variable may be recorded in the signature as one of a limited number of status descriptors or indicators such as, for example: “out of nominal range, high”; “within nominal range” and “out of nominal range, low” or “maintenance x required within time t”.

Computer analyses of the data within collections of signatures, as performed by the one or more central computers 17, may be employed for the following uses: triaging of instrument problems or failures by service personnel, scheduling of preventative maintenance of instruments by service personnel, providing operational feedback to research and development engineering personnel, providing operational feedback to manufacturing and process engineering personnel and providing operational feedback to instrument users. The computer analyses improve the efficiency of triage activities because they enable service personnel to quickly identify trends in the acquired signature data that allow categorization and/or isolation of problems and the narrowing of the range of possible root causes of noted symptoms or problems. Likewise, the computer analyses may improve the effectiveness of preventative maintenance activities through accurate prediction of the useful service lifetimes of various instrument components. These predictions inform instrument users of the appropriate times for performing user-responsible maintenance actions, inform research and development and process engineering personnel of any problematic components that are not meeting their expected performance or service lifetimes and inform manufacturing personnel of inventory requirements. Signature data may also include so-called “action category” entries or fields that may be populated with codes that provide alerts to users or service personnel of situations that require immediate or urgent action. One form of alert code may be directed to actions that are the responsibility of instrument users; another form of alert codes may be directed to actions that must be addressed by professional service personnel.

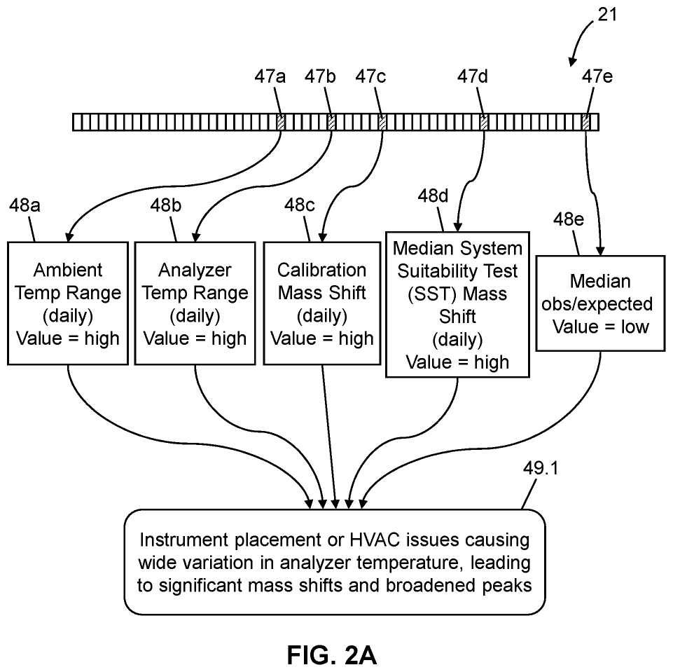

FIGS. 2A-2C illustrate the use of a simple signature for discriminating between different root causes of a commonly observed type of reduced performance—in this example, “low sensitivity” as observed in a liquid-chromatography/mass spectrometry system (LC-MS system) that combines a liquid chromatograph together with a mass spectrometer, An instrument-specific signature for such a system will include a record of variables relating to both the liquid chromatograph (LC) sub-system and the mass-spectrometer (MS) sub-system, The signature 21, which, for simplicity, is indicated as a simple array of values in FIGS. 2A-2C, may include, without limitation: values of LC status variables; values of MS status variables; application-specific quality-control metrics such as those obtained by measurements of standard samples in accordance with various applications; mass spectrometer calibration information; and scheduled diagnostic evaluation information. One can envision the system signature as providing a complete system snapshot at a particular time. In some embodiments, the set of values composing the signature 21 may be provided in a simplified encoded form comprising data descriptors, such as Boolean data descriptors in which, e.g., the value “1” denotes a measured value of a variable that is out-of-bounds and 0 denotes a normal or within-range value. It is emphasized that the present teachings are not limited to the use of either an array of values, a set of encoded values or one or more barcodes as an instrument signature. In fact, a signature may be provided as or represented by any structured set of data composed of one or more of ASCII string variables, integer variables, Boolean variables, real-number variables, etc. In certain preferred embodiments, the signatures are provided in either JavaScript Object Notation (JSON) file format or JavaScript Object Notation for Linked Data (JSON-LD) file format.

In the example illustrated in FIGS. 2A-2C, the symptom of “low sensitivity” would not, by itself, allow a confident diagnosis of a root cause of the problem. In fact, as is schematically indicated in FIGS. 2A-2C, only a combined analysis of multiple variables can correctly diagnose the problem. FIG. 2A indicates that a particular set of values of variables 47a, 476, 47c, 47d and 47e, the particular set of values being indicated in boxes 48a, 48b, 48c, 48d and 48e, respectively, leads to the diagnosis described in box 49.1. Alternatively, FIG. 2B indicates that a particular set of values of the different set of variables 47f, 47g, 47h, 471, 47j, 47k and 47e, the particular set of values being indicated in boxes 48f, 48g, 48h, 48i, 48j, 47k and 47e, respectively, leads to the different diagnosis described in box 49.2. Otherwise, as indicated in FIG. 2C, a particular set of values of the different set of variables 47L, 47m, 47n, 47o, 47p, 47q and 47e, the particular set of values being indicated in boxes 48L, 48m, 48n, 48o, 48p, 47q and 47e, respectively, leads to the different diagnosis described in box 49.3. Note that while the user-identified issue is the same in each of the three examples illustrated in FIGS. 2A-2C, the required corrective action is very different in each individual situation. These examples illustrate that an identification of a particular subset of metrics which are simultaneously shifted from their respective norms can enable an accurate root cause diagnosis or, in other cases, prediction of future issues.

In accordance with the present teachings, the received data pertaining to each individual apparatus or system is analyzed by software, preferably artificial intelligence software, in order to recognize patterns or groupings of deviations of the instrumental variables from their nominal values that are diagnostic of a particular mode of instrument failure or reduction in instrument performance. The analyses are also performed in order to recognize patterns or correlations of time-variation of the instrumental values that may be used to predict how and when a failure or a reduction in instrument performance will occur. When matched to one or more particular modes of failure of an apparatus, the collection of such recognized patterns, groupings and/or correlations form the information basis upon which so-called “classifiers” can be constructed for the particular apparatus. Alternatively, classifiers may be developed for a particular class of analytical apparatus by analyzing, with the artificial intelligence software, consolidated instrument-specific signature received from all apparatuses or systems of the particular class.

In order to develop classifiers, an observed trend, grouping or correlation in the instrumental variables must be matched to an actual failure mode or an observed reduction in performance, as determined in the field by service personnel through direct observation. In this way, the artificial intelligence software is trained. By means of such training, it is expected that the accuracy of classifiers should improve with time.

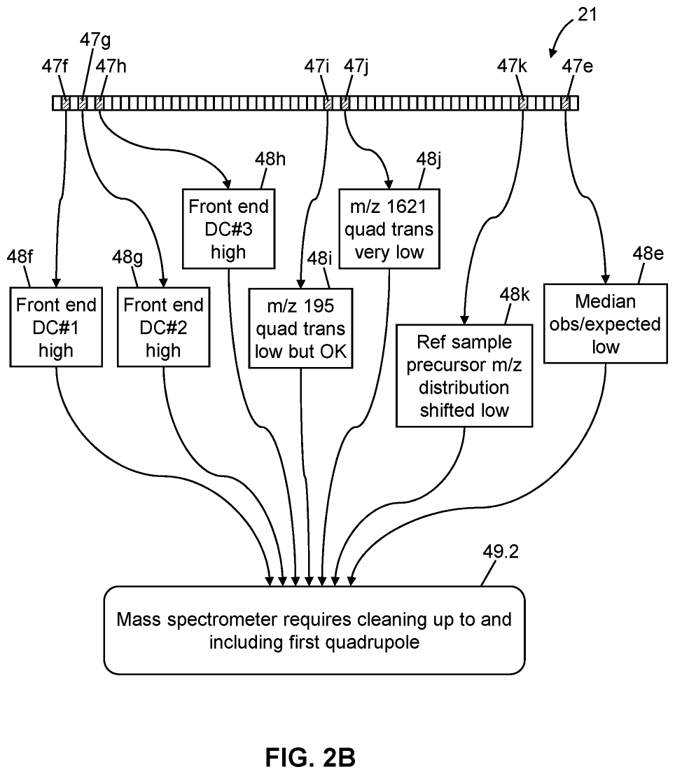

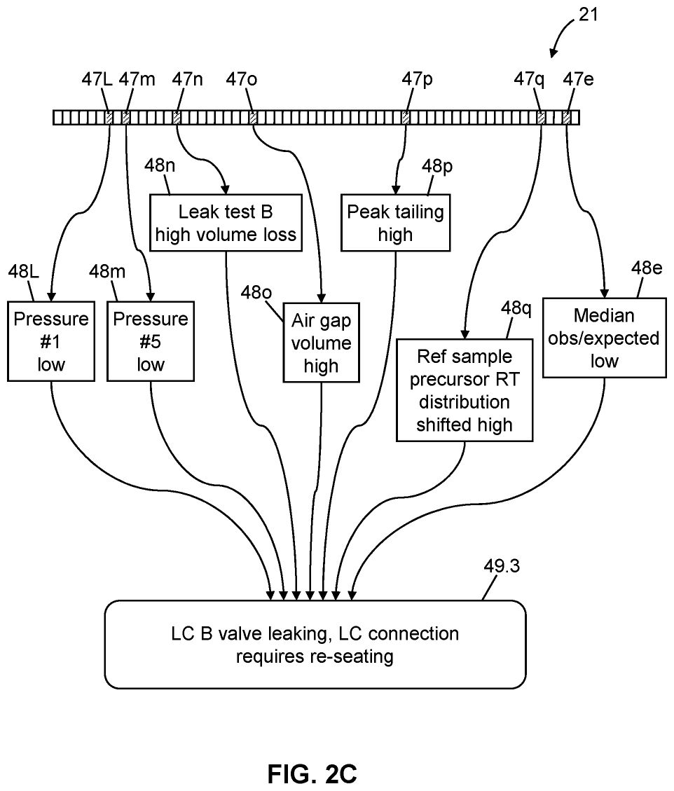

An initial training set composed of existing historical data or observations may be input to the artificial intelligence software when the networked system 10 is to be constructed or when a new class of apparatus is to be introduced into the system for the first time. In general, the historical data will have been obtained by means of the conventional instrument servicing and support procedure described above. Unfortunately, such historical data may be incomplete or inconsistent, either in terms of the recordation of pertinent instrumental variables, user actions and descriptions of root causes of failure or in terms of the number and types of potential failures actually observed. Thus, any classifiers developed using the initial training set are likely to be only approximately or partially accurate. For this reason, the networked system 10 is configured to constantly update the training set by means of: constant transmission of instrument-specific signature 21 to the central location 16; and occasional input, into one or more databases of the data storage module(s) 18, of problem-resolution descriptions 26, including information about replacement parts required, service hours required, assessments of root causes of failure, etc. by service personnel (see FIGS. 3A and 3B). As used herein, the term “central location” is used in a broad sense to refer to either a single site or a collection of sites, each comprising one or more physical buildings, at which shared computing resources are housed. Accordingly, a central location may comprise computing resources housed at either a single campus or at a plurality of campuses. Regardless, the central location, so defined, is/are remotely located relative to the analytical apparatuses or analytical systems discussed herein.

FIGS. 3A and 3B provide a schematic illustration of how such updated training may be performed. When an instrument failure or unacceptable reduction in instrument performance occurs, a field technician or engineer 25, 65, 75 is dispatched to the site at which the failure or performance reduction has occurred. In the example depicted in FIG. 3A, one instance of each of apparatuses or systems 11, 12 and 13 have developed issues which require a visit from an appropriately trained field technician or engineer. Field technician or engineer 25 is an expert in apparatus or system 11, while field technician or engineer 65 is an expert in apparatus or system 12 and field technician or engineer 75 is an expert in apparatus or system 13. The field technicians or engineers analyze, possibly in coordination with factory personnel, analyze the failure or reduction in performance in order to determine its root cause and make whatever adjustments, repairs or component replacements are necessary to restore, performance. Finally, the field technician or engineer updates and augments information on one or more databases of the data storage module(s) 18 by entering a problem-resolution description 26 into the database. All such problem resolution descriptions 26 should conform to a consistent format and should provide a description of the means employed to resolve the observed problem and, if determined, a description of a root cause of the failure or performance reduction as well as possibly additional information.

Subsequently (FIG. 3B), the artificial intelligence software may be re-executed using the fully augmented database entries relating specifically to the instrument on which the service and repair was performed. A separate re-execution of the artificial intelligence software may use the fully augmented database entries relating to the entire class of apparatus or system to which the serviced instrument belongs. The artificial intelligence software running on the one or more central computers receives the database information 27 from the one or more databases and may determine if the existing classifiers require updating, based on the newly-entered information. If necessary, the software calculates one or more new classifiers 28 and records the new classifiers on the database. A first classifier may pertain to the recently-serviced instrument(s). A second classifier may pertain to the entire class of apparatus or system to which the recently-serviced instruments) belongs.

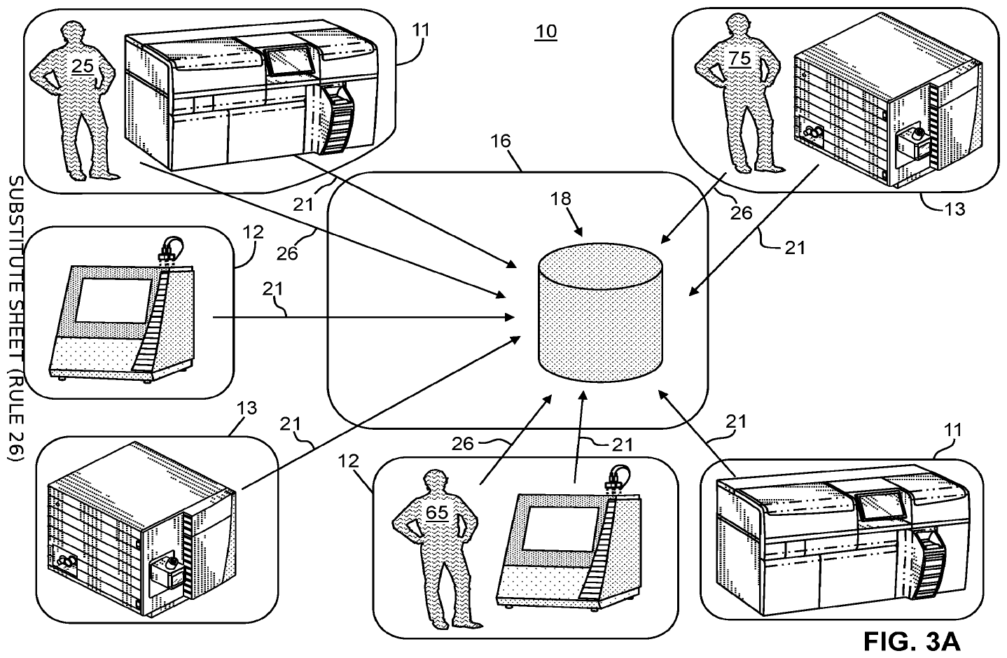

FIG. 4 is a schematic depiction of hardware and software architecture of a system for monitoring and maintaining optimal operation of a plurality of analytical apparatuses or analytical systems in accordance with the present teachings. The depiction in FIG. 4 includes communication between the site 9 of a general data analysis apparatus or system—such as one of the devices 11, 12 or 13 shown in FIG. 1 or some other type of data analysis apparatus or system—and a central location 16 comprising one or more central computers 17 and one or more databases of a data storage module 18. Two such databases, 111a and 111b are shown in this figure. Although only a single site 9 is illustrated in FIG. 4, the central location 16 will, in general, be in communication (either intermittently or essentially simultaneously) with a plurality of such sites, possibly comprising several different types of data analysis instrumentation.

The various data acquisition hardware components, as well as associated device drivers, dedicated control software, firmware, etc. are depicted generally at 101 in FIG. 4. The control software or firmware module (or modules) comprise(s) computer code that periodically records the value of each one of several variables—such as various temperatures, pressures, voltages, etc.—that are important for providing a record of instrument performance that can be later analyzed in accordance with the present teachings. These values may be recorded with either the same or different respective periodicities. A single site may house multiple operating analytical apparatuses. In some situations, a single analytical apparatus may comprise more than one control software or firmware module; such instances commonly arise when an analytical apparatus comprises a plurality of sub-systems.

Although a different set of variables may be recorded for each sub-system or for each type of instrument, it is preferable that the information from all such control modules is communicated to the central location 16 in accordance with either a common format or a common schema. Preferably, the signature format should also be flexible and future-proof. In simple implementations, the signature data may be communicated to the central location in a native computer binary-code format, such as an array of floating-point numbers, that is consistent among all apparatuses. However, there may be some disadvantages to communicating signature data in that way. For example, such a format makes it difficult to add new features; if one instrument requires a change, then all others must upgrade at the same time. Further, different classes of instruments will generally have different release cycles. For such reasons, it is preferable to use a flexible communications approach and data structure.

The inventors have recognized that JavaScript Object Notation (JSON) and/or JavaScript Object Notation for Linked Data (JSON-LD) are data representation formats that may be readily employed for the purpose of communicating signature data, since these formats are in widespread use, are highly flexible and adaptable, are easy to read and write and are compatible with most programming languages. These types of data representation are not tied to any particular programming language, framework or architecture and maintain flexibility so that each instrument development team may continue to add and modify features of particular instruments, as needed. Each type or class of apparatus may comprise its own unique internal variable types and data representations, provided that the signature data is properly translated into JSON or JSON-LD format at each local site 9 (see FIG. 4) and that the JSON or JSON-LD signature representations are appropriately validated at the central location 16. According to the present teachings, communication of signature data may advantageously employ a novel JSON or JSON-LD schema that is compatible with an appropriate ontology such as the SOSA, QUDT, SKOS, or OWL-Time ontologies, ontologies developed by the Allotrope Foundation™ or another suitable ontology, as appropriately modified according to the engineering requirements for signatures noted above.

The packaging of local instrument data into the JSON (or other) signature transmission format is performed at the driver or firmware level 101 of each individual instrument.

The signature data is then passed to a communications hub 103 at which it is authenticated and encrypted. The authentication ensures that the signature comprises a valid format and originates from an authorized data source. The encryption step ensures that the signatures cannot be wiretapped, spoofed, or tampered with during their subsequent transmission to the central location 16.

Data signatures from each device are transmitted from the communications hub to a network connection agent 105 that comprises a plurality software or firmware modules (here shown as modules 105a, 105b, and 105c). The connection agent 105 serves as the main communications interface between the central location 16 and either an individual data analysis instrument at the site 9 or, potentially, the entire site. The connection agent 105 also performs the function of storing the encrypted signature data in a database 107 that is local to the site 9. Direct Internet transmissions are managed by an Internet-facing communication sub-module 105a. that is responsible for transmitting validated and encrypted signature data to the central location 16 by means of an Internet connection 131. If necessary, another sub-module 105b of the connection agent 105 may create a package of service-related information 109 (here referred to as a “service bundle”) that may be consulted by a service technician or engineer in the case of an instrument fault or malfunction. Such service bundles are provided in a conventional report format that is intended to describe the nature of an observed instrument fault or failure to service personnel for their use in determining the possible causes of and remedies for the fault or failure.

Preferably, the connection agent 105 also comprises a user interface sub-module 105c that communicates with a user terminal 126 by which users may set various preferences for information transmission timing and for the manner in which information is transmitted. Instrument status and other notifications may be sent to users through the user interface sub-module 105c and user terminal 126. For example, action category alerts that require user actions, such as maintenance actions, may be provided to users in this fashion.

According to some embodiments, a separate communications hub 103 and a separate connection agent 105 may be provided for each analytical apparatus. However, in some instances, a single site 9 comprises two or more analytical apparatuses that communicate with the central location 9. According to some embodiments, only a single communications hub 103 and a single connection agent 105 may service all of the instruments at the site.

At the central location 16, direct communications of encrypted instrument signatures from the various sites 9 are received by signature bundle importer module 119 that executes on the one or more central computers 17. All such signatures are stored in a central database 111a. A service administration module 115 maintains service-department records relating to administrative tasks, bookkeeping, logistics etc. on a service database 111b with which it is in communication. The information in such records may include, without limitation: labor hours, ticket opening and closing data, costs incurred, parts ordered, billing information, codes relating to problem severity, and codes relating to root causes of problems, the latter of which may be entered by service personnel through user interface 125. The service database 111b may also contain root cause and malfunction symptom codes that are, entered into the database by service personnel during service calls to instrument sites. Such codes may be accessed by the one or more central computers 17 and used to annotate signature entries in the central database 111a. Although the service database 111b is schematically illustrated as being located at the central location 16 in the schematic example illustrated in FIG. 4, the service database 111b may be located at a different location that is remote from the central location. A signature rules engine module 113 may extract action category codes from signature data, record the extracted information and, in certain cases, route messages to the appropriate service personnel to alert them of a need to perform an action, based on the code.

Preferably, the one or more central computers 17 comprise one or more data-visualization and data-analysis software modules that may be accessed by instrument-vendor personnel, service-department personnel or instrument users/owners by means of a terminal or computer system 125. Generally, the terminal or computer system 125 will be remote from the central location 16 but, in some instances, the terminal or computer system 125 terminal or computer system may be on-site at the central location. Depending upon their respective roles, interested personnel will have access, via their user interface 125, to a particular subset of the data-visualization and data-analysis software modules. Four such modules, 121a, 12113, 121c, and 121d, are illustrated in FIG. 4. The ALMANAC™ software module 121a, in addition to its other functionality, allows users to access information that relates to actions that may be addressed by laboratory personnel and instrument users. The “Query Tool” module 121b provides a user interface to analytical instrument research and development personnel and system development engineers that enables them to validate the accuracy of data that is being received from one or more of the plurality of analytical instruments. The annotation tool module 121c provides a user interface to engineering and service personnel that enables them to view one or more system signatures at a given point or points in time, The annotation tool module 121c may also be employed to augment system signature data, as reported by the instrument control software, with in-the-field observations and root-cause-of-failure determinations, as entered by service personnel during servicing and repair visits. Thus, the annotation tool module correlates instrument signatures in the database 111a to relevant structured-service-data in the database 111b. The triage module 121d makes use of computer analysis of the annotated signature data, such as artificial intelligence data analysis, in order to provide service personnel with a list of most probable root causes of an instrument fault or failure prior to or at the time of making a service visit. The triage module 121d may also provide the service technician or engineer with a list of appropriate parts and/or tools that the technician or engineer should have at his/her disposal at the time of the service visit. The triage module may, in some instances, submit parts orders to a warehouse, factory, or other parts vendor so that the appropriate parts are available at the time of the service visit.

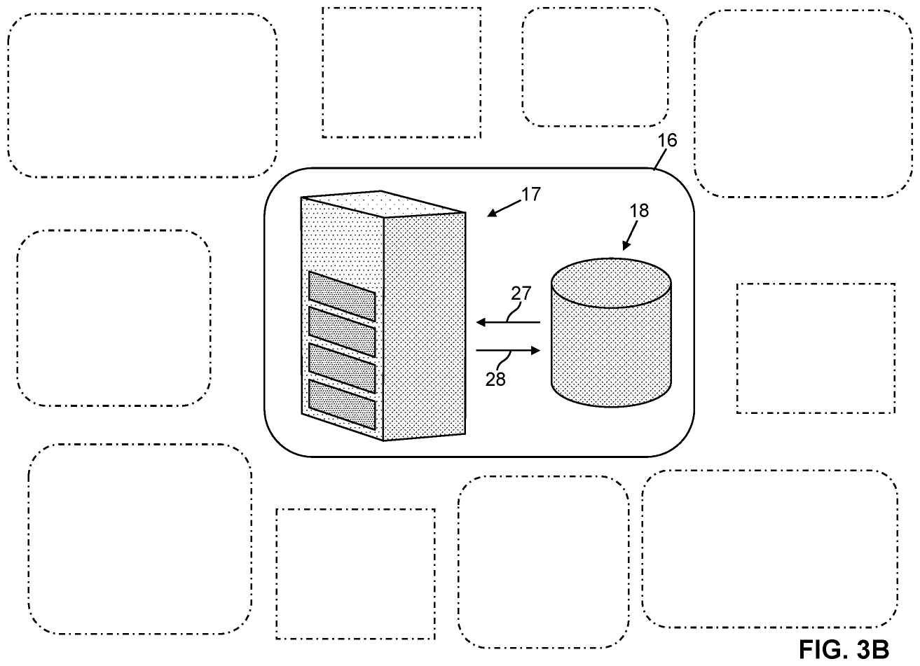

FIGS. 5A-5C are schematic illustrations three different preferred methods for generating, analyzing and conveying data within a system in accordance with the present teachings. The methods 201, 202 and 203 depicted in these figures range from most-highly-automated connectivity to the central location 16 to least-highly-automated connectivity to the central location 16 in the order from FIG. 5A to FIG. SB to FIG. 5C. Various subsets of sites 9 within the networked system 10 may operate in accordance with a respective one of the methods 201, 203 and 205 depending on the preferences and resources available to the various site operators or owners. Alternatively, different analytical apparatuses or systems within a single site 9 may participate in the network 10 in accordance with different ones of the methods. Further, some analytical apparatuses or systems may participate in the networked system 10 while others do not participate at all.

Method 201 (FIG. 5A) corresponds to fully automated continuous connectivity between an analytical apparatus at a site 9 and the central location 16 by means of a direct Internet connection 131 (FIG. 4). In accordance with this method, the connection agent module 105 that is associated with a particular analytical apparatus or system periodically transmits properly formatted encrypted signature data to the central location 16, at which this data is added to the database 111a. The delay between successive data transmissions may be on the order of several seconds or several minutes up to several hours. The data is then immediately available for visualization or analysis by one or more of the of data-visualization and data-analysis software modules, such as modules 121a, 121b and 121c, that execute on computers at the central location 16.

According to the method 203 (FIG. 5B), there is no direct Internet connection between the ICS Agent module 105 and the central location. Although signature data from one or more analytical apparatuses at a site is periodically generated as in the method 201, this data is not immediately transmitted to the central location 16. Instead, the recently-generated signature data from one or more analytical apparatuses is stored in a database 107 that is either local to the instrument site or that is otherwise coupled to a proprietary intranet network to which the analytical apparatus(es) is/are also coupled. This data is continuously generated and collected on the database 107 for a certain time period, T_{c}. The time period, T_{c}, need not be constant but may vary in accordance with local factors and/or user preferences. For example, T_{c}, may depend on the workloads of the particular analytical apparatuses. After elapse of the collection time period, all of the signatures that have been stored in the local database since a prior transmission are collected and transmitted, possibly together with additional relevant information, to the central location 16 by the communication sub-module 105a of the connection agent module 105. At the central location 16, the signature bundle importer module 119 continuously watches for such transmissions from local sites 9. Once a legitimate valid transmission has been detected, the signature data is extracted and stored to database 111a and other relevant information may be stored to database 111b.

The method 205 (FIG. 5C) is similar to the method 203 (FIG. 5B) with the exception that stored signatures are not automatically packaged and transmitted from a site to the central location 16 and, accordingly, such transmissions are not continuously watched for by the signature bundle importer module 119. Instead, collected instrument-derived data is locally packaged, at irregular times, into service bundles or other collections of signature data (e.g., signature bundles) through direct intervention by or at the behest of site personnel. The creation of the service bundles or signature bundles at a site that operates in accordance with the method 205 may include some manual intervention by site personnel. Once created, the service bundles or signature bundles may be transmitted to the central location 16 by means of a temporary Internet connection. Alternatively, service bundles and/or signature data may be retained at the local site until an authorized or trusted service technician or engineer makes an in-person visit to the site. While on-site, the service technician or engineer may create and download the service bundles or signature data to a transportable computer memory device (for example, a hard disk drive or solid-state drive in a portable computer) that remains in custody of the service technician or engineer. The service engineer may later upload the collected data to the central location 16 by means of a user interface 125.

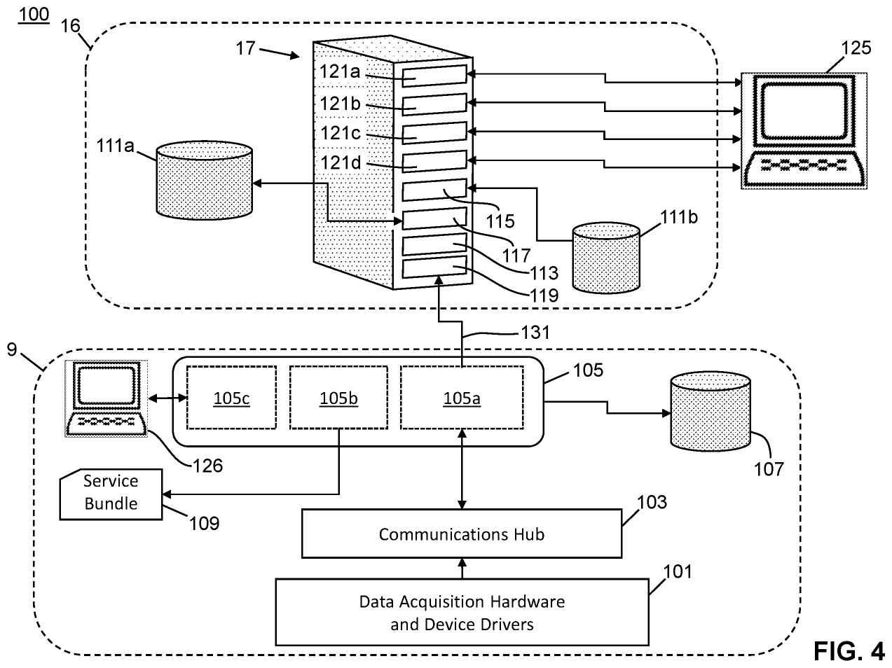

Preferably, the content and organization of signatures and the content and/or organization of signature data on the one or more databases are such that otherwise-unknown groupings, trends or other bits of information in, the data can be uncovered using the defined categories, properties, concepts, relations and entity definitions of one or more standard ontologies (sometimes known as “knowledge graphs”), as used in information science. Once uncovered, the groupings, trends and other information can be advantageously used in a variety of ways. Table 1 in FIG. 6 is a listing of the usage cases that that should be supported by information contained in the database.

Usage case number 1 covers situations in which service call triage is performed automatically and/or remotely. The provision of mineable organized data within the database(s) can allow artificial intelligence analysis to recognize trends that can be presented to service personnel as a list of most probable causes of a service issue. Alternatively, experienced service personnel can query the database to rapidly discern relevant trends that can point to the most probable causes. These capabilities can increase the percentages of service-call issues that may be resolved either remotely or at the time of a first visit by a service technician, thereby overall repair time and cost per service call. Most collected data will support this use case.

Usage cast number 2 of Table 1 (FIG. 6) pertains to remote monitoring of expected, use-dependent performance decline or failure, thereby reducing instances of unplanned down time by enabling need-dependent scheduling of preventative maintenance. This use case can be addressed immediately if maintenance thresholds for key components are a priori known. Otherwise, analysis of the collected data can enable recognition of maintenance thresholds.

Usage case number 3 of Table 1 pertains to rapid and/or automatic service response to acute or directly actionable system or parts failures. Such capabilities not only reduce overall apparatus downtime but also ensure that safety concerns are acted upon immediately. According to some embodiments of systems and methods in accordance with the present teachings, technical support is automatically notified when an event has occurred that requires service recovery action.

Usage case number 4 of Table 1 covers situations in which research and development factory personnel utilize data collected from a plurality of apparatuses in order to recognize trends that enable recognition and correction of systemic issues in a timelier fashion than was previously possible. This usage case may relate to, without limitation, hardware, instrument control software, calibration algorithms, and user-interface software. Where available, this use case is supported by metrics that confirm part function and/or failure. Similarly, manufacturing and process systems engineering personnel may utilize the collected data, in accordance with usage case number 5, to more-accurately monitor parts and equipment inventories, to order and/or deliver parts for needed service calls, as well as to confirm proper part replacement on service calls. Finally, in accordance with usage case number 6, users may be provided with maintenance recommendations and various status updates.

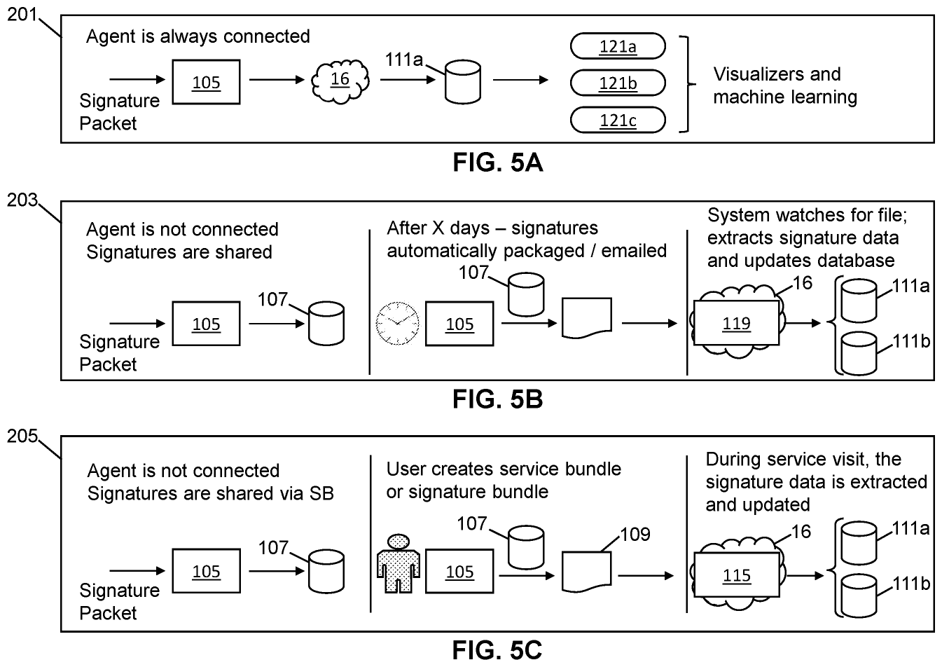

Table 2 in FIG. 7 lists various categories of actions that may be indicated by the data that is collected in accordance with the present teachings. Action category codes may be embedded within signatures that are transmitted by an apparatus or by components of an apparatus to the one or more central computers 17. Alternatively, the action category assessments may be referenced at the central location in response to analysis of received signatures. The purpose of the action category is to ensure response in a timely manner, without requiring analysis of the data by a subject matter expert. In some instances, the action may include automatic issuance of an alert, warning or advisory note to a user or to service personnel through a user interface, an email message, an internet direct message, etc. The text of such warnings, alerts or advisory notes may be embedded in certain of the signatures, or referenced from a manifest document stored at the central location.

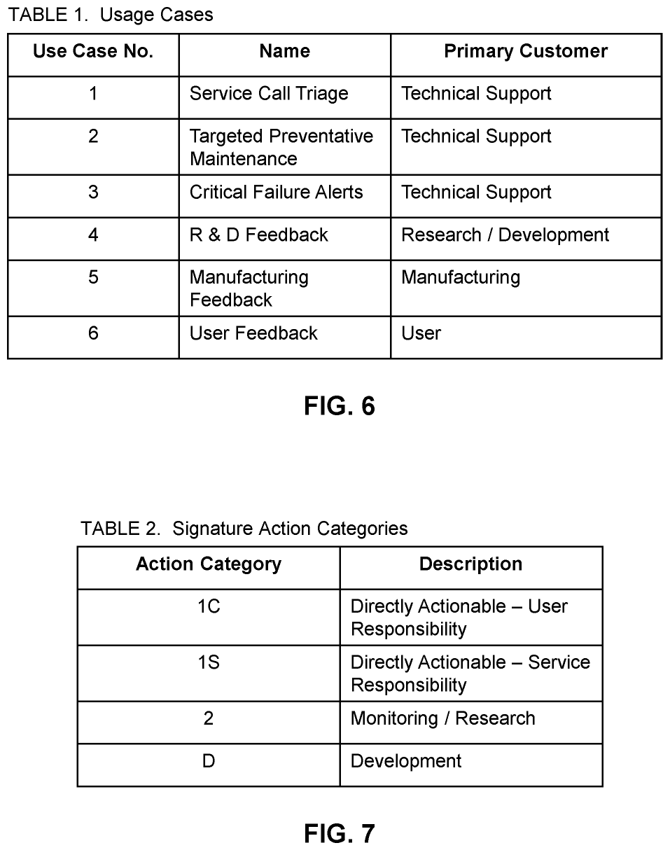

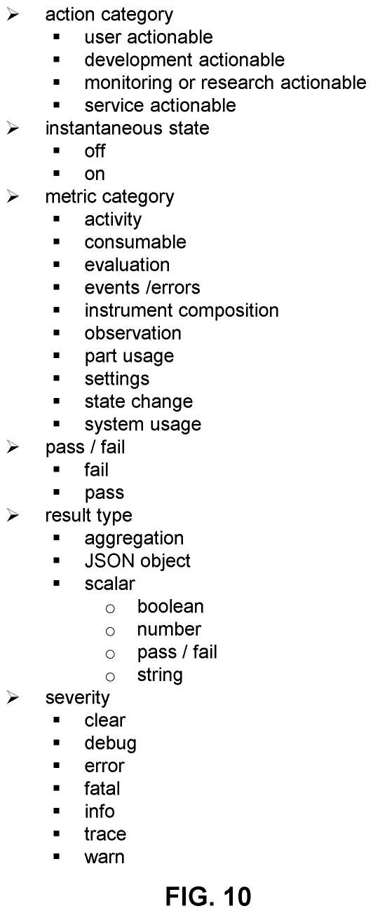

Action category 1C pertains to required actions that are the responsibility of users. Users may be directly alerted to the need to perform a certain action—for example, replenishing a consumable, introducing a calibration sample, etc.—through a user interface of instrument control software, remote monitoring software, or mobile device. Action category 15 pertains to required actions that are the responsibility of service personnel. When the need for service action is detected, an alert and any required data may be routed immediately to technical support personnel. Concurrently, a service ticket may be opened automatically. A 1S action categorization encompasses one or the other of two different usage cases (see Table 1 in FIG. 6): targeted or use-based preventative maintenance (usage case number 2) or critical failure alerts (usage case 3). This action category may be communicated and/or assigned within the events/errors metric category (see FIG. 8 and FIG. 10 discussed further below). Finally, an action category “D” may be provided for the collection of raw data that may be used for the purpose of improving the presently-taught methods and systems but that is not used for any other purpose.

As noted above, signature data may be provided in any computer-readable structured data format. However, for maximum benefit, it is desirable that collected data is structured in accordance with the semantic definitions of objects, measurements, data linkages, etc., as defined in one or more of the various ontologies discussed above or as defined in technologies collectively known as the Semantic Web Stack. In such instances, it is desirable that signature data is communicated and structured in accordance with the syntax of JavaScript Object Notation for Linked Data (JSON-LD). The JSON-LD structure may be consistently employed among signatures pertaining to various apparatuses and systems, including full analytical systems, sub-systems of hybrid systems (for example, a chromatograph component of a hybrid system that also includes a mass spectrometer), individual device components (e.g., an on-board centrifuge) as well as individual parts (i.e., a temperature controller board). Validation of such signatures is essential. To be valid, such signatures must: (a) conform to the JSON-LD specification; (b) conform to the JSON schemas provided during setup or definition of the general networked system 10 (FIG. 1); (c) include only references that unambiguously resolve to a specific system, sub-system, component, part, software version, etc.

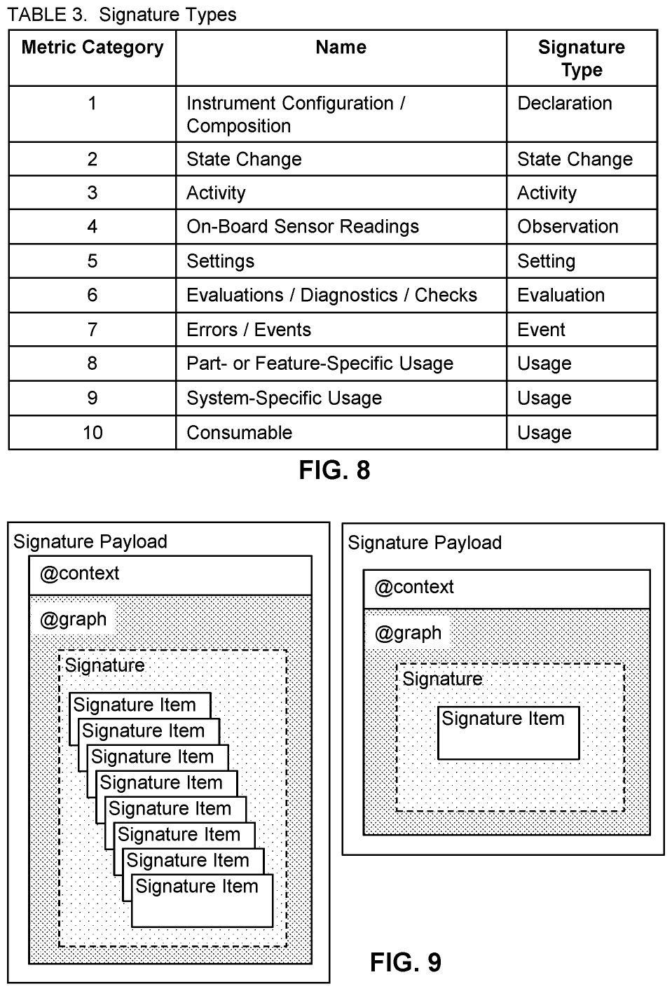

A schematic depiction of two types of JSON-LD signature communications, as used in methods and systems of the present teachings, is provided in FIG. 9. Signatures are like messages, capable of conveying a great deal and variety of data. Signatures describe things like connected hardware, readings from sensors, and the outcome of tests they run on themselves. They can also convey information regarding events that occurred, the usage of parts and components, and much more. The signature data is generated at runtime by instrument control software. The generated signatures must conform to a consistent signature schema.

Each measurement or event, whether at the system, sub-system, component apparatus, or individual part level, carries specific reference information/metadata. The dynamic information that is specific to a given instrument (or component, part, etc.) at a given point in time or span of time is captured in a signature communication. An individual signature might contain information about a single event, for instance, in the case of an error or a state change. Alternatively, it may contain a great deal of data spanning many hours of collection, for instance, the aggregation of multiple sensor readings.

The left side of FIG. 9 depicts a signature communication that comprises a signature payload that includes a plurality of signature items. This type of communication is most relevant to communication of multiple scheduled observations that occur according to a same schedule. The right side of FIG. 9 depicts a signature communication of which the payload consists of a single signature item. This latter type of payload format is most applicable to the communication of unscheduled events or state changes. As depicted in FIG. 9, a signature payload may be broken into two top-level sections: the @context section which will be identical for every signature from a given device, component, etc.; and the @graph section, which is an array that is primarily used to convey data in the form of a plurality of signature items.

FIG. 10 is a listing of the various categories of information that may be communicated in signatures in accordance with the present teachings. The action categories have already been described with reference to Table 2 (FIG. 7). The various metric categories are here further discussed with reference to Table 3 in FIG. 8. Each item onset of measurement data that is included in a signature item is described in terms of one of these metric categories.

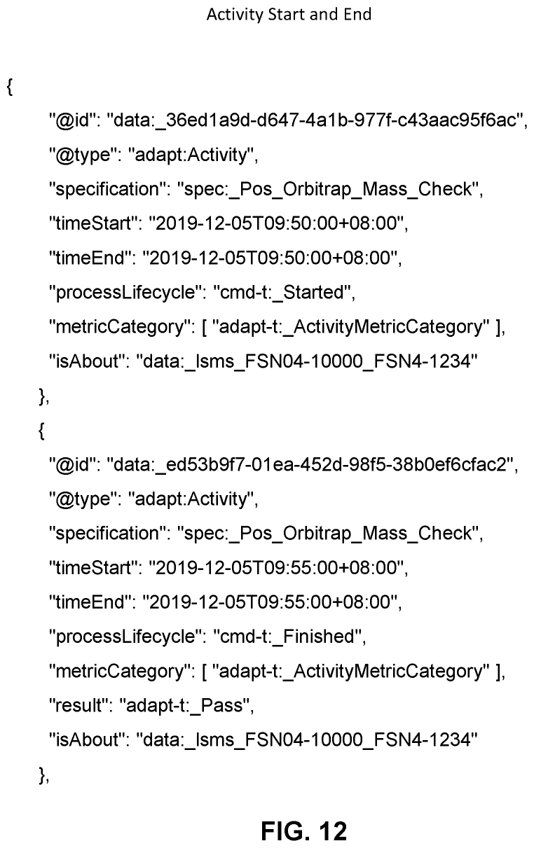

The instrument configuration/composition category (metric category number 1 in Table 3 of FIG. 8) includes system-, instrument- and module-level organizational identifiers, and other serial numbers and equipment material identifications (e.g., product part numbers). It may also include; part-specific serial numbers and part numbers where possible; all installed software and firmware version/build numbers; and other hardware configuration information that is not described by serial numbers, Metric category number 2 comprises reports of state changes, such as changes to “on”, “off” or “standby” states. Each reported state propagates forward in time; that is, it is assumed to persist until a new state is provided. Metric category number 3 comprises reports of various activities, such as calibrations, internal checks, etc, Initiation of the activity is reported as the variable “timeStart”; completion of the activity is reports as the variable “timeEnd” (e.g., see FIG. 12). At the conclusion of the activity, a result is reported as the variable “result”.

Metric category number 4 comprises reports summary statistics of diagnostically relevant readbacks (i.e., on-board sensor measurements, such as of temperature, pressure, voltage, electric current, etc.) together with their appropriate context. Multiple statistics may be used to describe a single readback. Metric category number 5 comprises reports numerical settings (calibrated or otherwise) of all devices including, if available, the results of calibrations. Metric category number 6 comprises numerical results of all user-triggered or scheduled sub-system evaluations, diagnostics, or checks that measure the efficiency of subsystems, especially those known to be altered as a function of use.

Hardware and software error records and codes are reported using metric category number 6. Such reports pertain to a single time point and may, where possible, be linked to an associated readback, diagnostic or check that triggered the error. Metric category number 8 is used for reports of part-specific or feature-specific usage. Such measurements provide context to the usage of particular parts and may, if possible, be linked to part-specific serial numbers. Metric category number 9 is used to report aspects of general system usage. Finally, metric category number 10 is used to report information relating to consumables, where applicable. The information may relate to the relative quantity or quality of various consumables.

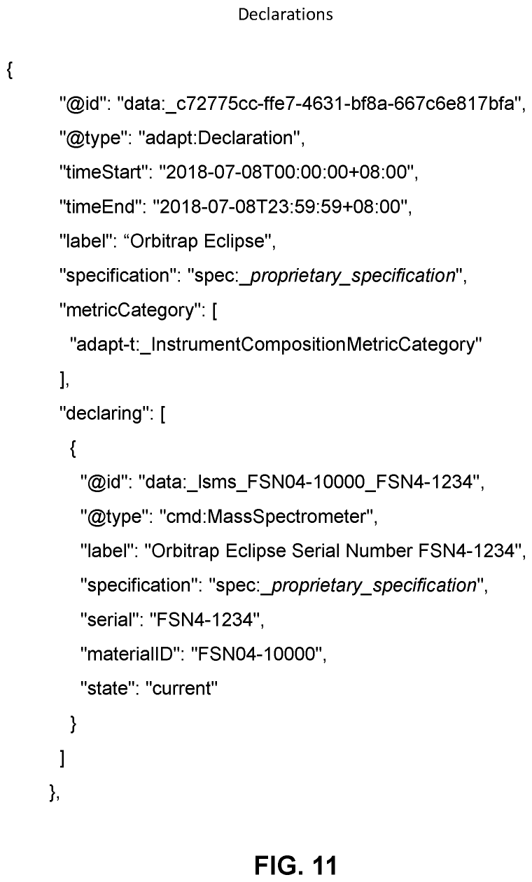

FIG. 11 is an example of a declarations signature item. The declaration is a signature item which declares the existence and organization of devices and systems. It may contain the serial number, product model, material ID, modules, channels, software/firmware versions, and physical components. A declared object can be a system, a simple device, or a piece of software. The declared object may be either physical or virtual (e.g., a virtual computer or, similarly, a virtual analysis apparatus). There are two aspects to every declaration: a declaration envelope that encapsulates a total of N (N≥1) individual declarations and that provides metadata for all; and a respective specification section for each declared object. Preferably, every declared object should have a material identification number (if available) or should otherwise have a model designation (if a physical object) or a version designation (if software). Every declared object can declare an array of child components. This array should be a list of components, each of which is explicitly declared separately. The child components can range in scale from subsystems down to individual parts. The information regarding declared objects propagates forward in time.

FIG. 12 is an example of a listing of a signature item that marks the start and end of a process, e.g., a process that an apparatus is performing such as calibration, evaluation, acquisition, etc. The “end” item can carry with it a “result” indication such as “pass”, “fail”, “complete”, etc. Activities persist between the start and end items. In the illustrated example, the start and end of an activity are broken out as separate signature items. Alternatively, they could have been combined into a single signature item. If an instrument abnormally ceased operation during an activity, separate “start” and “end” signature items allow one to discern that fact.

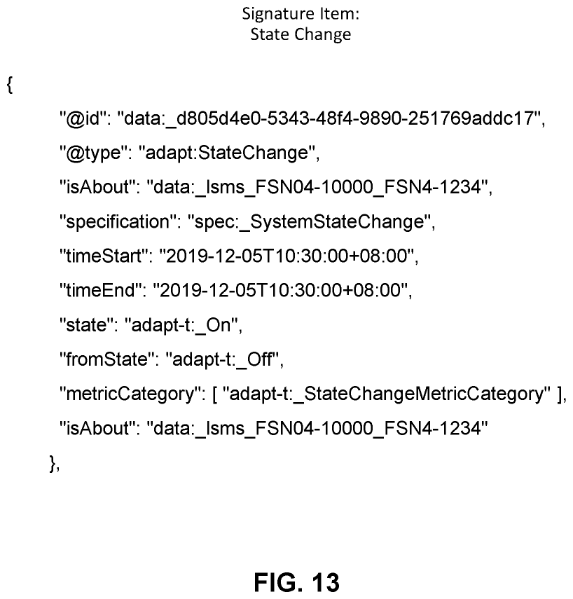

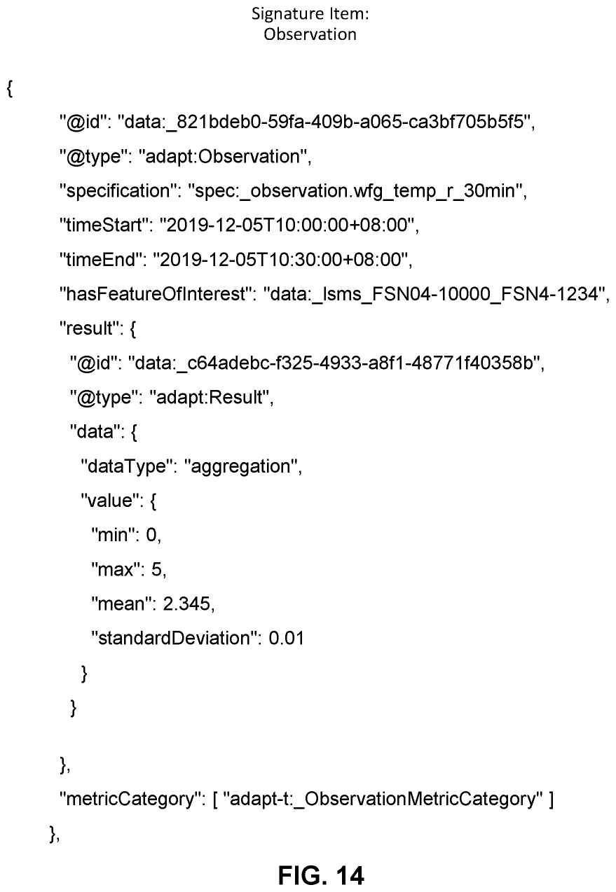

FIG. 13 is an example of a listing of a signature item that records a change in the functional state of an apparatus (e.g., on, off, standby, high-pressure mode, etc.). State changes propagate forward in time. FIG. 14 is an example of a listing of a signature item that records an observation. Observations may include readbacks from various sensors that measure certain quantities (e.g., temperatures, pressures, voltages, electric currents, etc.) in different parts of a system. The individual measurements may be reported as discrete values but, generally, are more useful when reported as statistically aggregated data (e.g., maximum, minimum, mean and standard deviation) as shown in FIG. 14. Statistical observations propagate, backward in time, since they are representations of states that occurred prior to the transmission of the corresponding signature item.

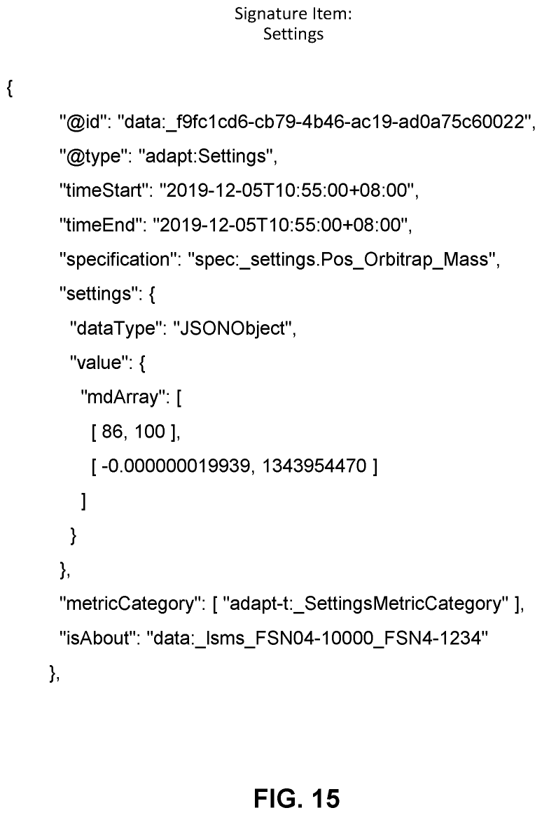

FIG. 15 is an example of a listing of a signature item that records instrument settings. Reported settings may include literal set points on components that are established through calibration or are set manually. Settings propagate forward in time.

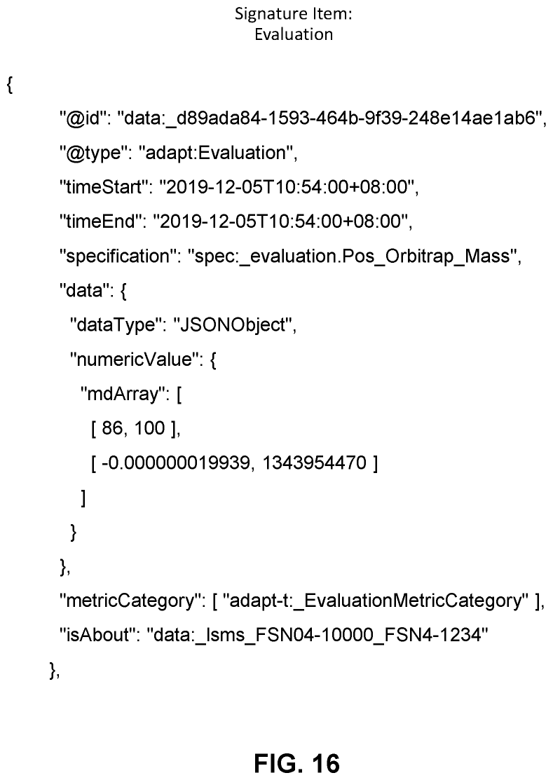

FIG. 16 is an example of a listing of a signature item that records results of an evaluation or diagnostic performed on the system or a component of the system. Pass/fail results that are elsewhere reported in activities-related signature items are dependent upon these values relative to some validated thresholds. Propagation of this data must be defined by data science, since such results carry weighted relevance that diminishes with time in both the forward and backward directions relative to the time of the evaluation, and also relative to equivalence of declared configuration.

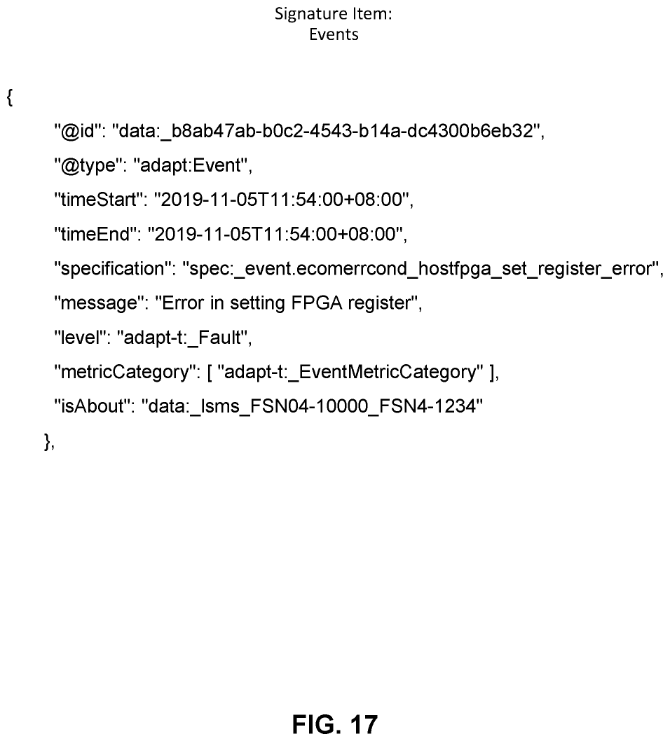

FIG. 17 is an example of a listing of a signature item that records the occurrence of an event. This type of signature item pertains to either errors or otherwise non-erroneous unscheduled events that occur irregularly. Events to not propagate unless it is indicated that a “clear” event should be expected, in which case they propagate forward to the time of the “clear” event.

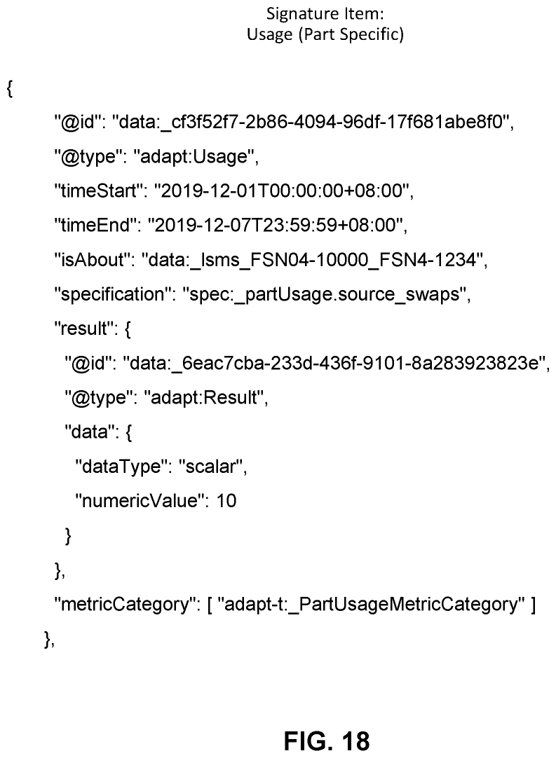

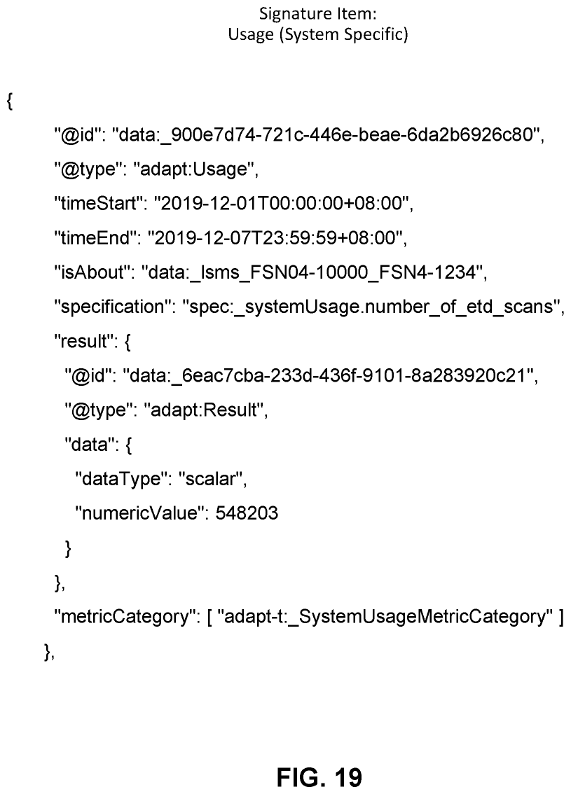

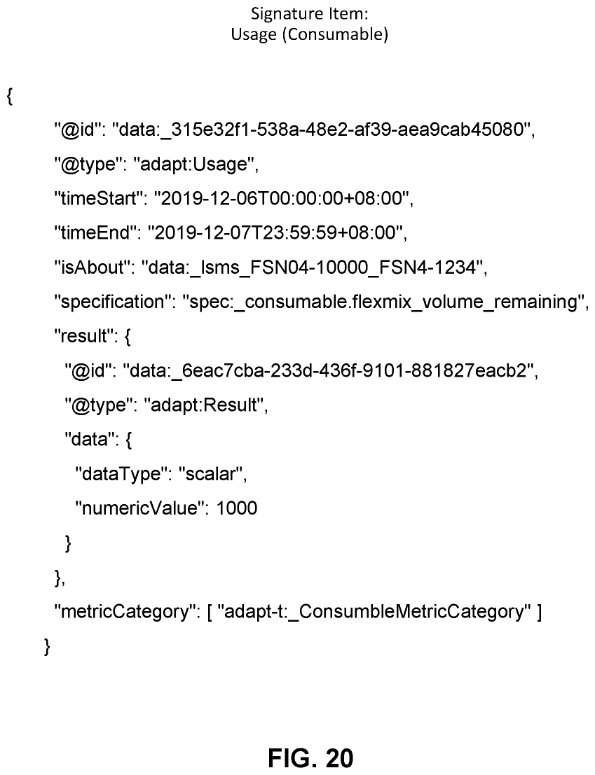

FIGS. 18-20 are examples of listings of signature items that record usage statistics. Such signature items type provide context regarding part, system, or consumable usage, and are therefore be divided into three different metric categories. Like observations, usage data are statistical aggregations over a time period, and therefore propagate backward in time.

Taken together, the collection of signatures that are transmitted from an analytical system in accordance with the present teachings can provide a very precise record of the state of the system at any point in time at a granular level, including information ranging in scope from system-wide down to the level of individual component parts. Some of the signature-related information may be either static, constant over extended periods of time or region-specific. In order to maintain transmission efficiency, such constant or relatively static or contextual signature-related information may be removed from the actual signature transmissions and maintained, instead, in a centralized repository, referred to as a “manifest”. For example, consider a particular temperature reading that is reported by signatures every ten seconds in degrees Celsius, that pertains to a particular part within a particular sub-system and that is measured by different types of temperature sensors, depending on place of manufacture. It would be a waste of communications resources to convey all of that information at each temperature measurement. Accordingly, the unchanging portions of the information—degrees Celsius, sensor type, part and sub-system, in this example—may be consolidated in the manifest. Distributing information in this way not only saves communications bandwidth but also creates the opportunity for manufacturing personnel, process engineering personnel and/or service personnel to update certain characteristics of their signature definitions as necessary, outside of software release schedules.

Systems and methods for remote monitoring, troubleshooting and service scheduling of analytical instruments have been disclosed. The discussion included in this application is intended to serve as a basic description. The present invention is not intended to be limited in scope by the specific embodiments described herein, which are intended as single illustrations of individual aspects of the invention, and functionally equivalent methods and components are within the scope of the invention. Indeed, various modifications of the invention, in addition to those shown and described herein will become apparent to those skilled in the art from the foregoing description and accompanying drawings. Such modifications are intended to fall within the scope of the appended claims. Any patents, patent applications, patent application publications or other literature mentioned herein are hereby incorporated by reference herein in their respective entirety as if fully set forth herein, except that, in the event of any conflict between the incorporated reference and the present specification, the language of the, present specification will control.

1. A system comprising:
a central location comprising:
computer storage media having one or more databases thereon; and
one or more computers configured to communicate with the computer storage media; and
a plurality of sites, each site comprising:
an analytical apparatus; and
a site computer system comprising program instructions operable to generate a plurality of apparatus signatures, each apparatus signature comprising a collection of data relating to the operation of the analytical apparatus at a time at which the said signature is generated,
wherein the one or more computers at the central location are configured to store the plurality of signatures from each of the plurality of analytical apparatuses in the one or more databases.

2. A system as recited in claim 1, wherein each analytical apparatus is chosen from the group consisting of: a mass spectrometer, a liquid chromatograph mass spectrometer (LCMS) system, a gas chromatograph mass spectrometer (GCMS) system, an electron microscope, an optical spectrometer, an X-Ray diffraction analyzer and an X-Ray fluorescence analyzer.

3. A system as recited in claim 1, wherein each site computer system is operable to store the plurality of apparatus signatures generated at the respective site and to transmit the stored apparatus signatures to the one or more computers at the central location.

4. A system as recited in claim 3, wherein each site computer system is operable to validate and encrypt the stored plurality of apparatus signatures prior to transmitting them to the one or more computers at the central location.

5. A system as recited in claim 3, wherein each transmitted apparatus signature is transmitted in in either JavaScript Object Notation (JSON) format or JavaScript Object Notation for Linked Data (JSON-LD) format.

6. A system as recited in claim 1, wherein the signatures employ defined categories, properties, concepts, relations and entity definitions in accordance with one or more standard ontologies.

7. A system as recited in claim 1, wherein the one or more computers of the central location is in communication with a service database on which are stored records pertaining to at least one of the group consisting of: service labor hours, service ticket opening and closing, service costs incurred, parts ordered, and billing information.

8. A system as recited in claim 1, wherein the or more computers of the central location comprise a module that provides a user interface to research and development personnel that enables validation of the accuracy of data that is being received from one or more of the plurality of analytical apparatuses by the one or more computers of the central location.

9. A system as recited in claim 1, wherein the or more computers of the central location comprise a module that provides a user interface to engineering and service personnel that enables said personnel to view one or more system signatures at a given point in time or at specific points in time.

10. A system as recited in claim 9, wherein the module comprises computer readable instructions that enable service personnel to augment system signature data with in-the-field observations and root-cause-of-failure determinations.

11. A system as recited in claim 1, wherein the one or more computers of the central location comprise a data analysis module that is configured to recognize trends in the signature data stored in the database.

12. A system as recited in claim 11, wherein the or more computers of the central location comprise a triage module that provides a user interface to engineering and service personnel that and provides said personnel with a list of most probable root causes of a fault in or failure of an analytical apparatus.

13. A system as recited in claim 12, wherein the triage module comprises computer readable instructions that are configured to provide a service technician or engineer with a list of appropriate parts and/or tools that the technician or engineer should have at his/her disposal at the time of a service visit to the analytical apparatus at which the fault or failure occurred.

14. A method comprising:
generating, at each one of a plurality of analytical apparatuses, each analytical apparatus being disposed at a respective site, a collection of apparatus signatures items, each apparatus signature item comprising a collection of data relating to the function of the analytical apparatus at a time at which the said signature item is generated;
transmitting each collection of apparatus signature items from the respective site of the respective analytical apparatus to a database at a central location; and
generating a full-system signature of each one of a subset of the analytical apparatuses by combining information from a plurality of the signature items.

15. A method as recited in claim 14, further comprising:
annotating at least a portion of the full-system signatures with information determined by service personnel in response to failures or reduced performance of one or more of the subset of analytical apparatuses.

16. A method as recited in claim 15, further comprising:
using algorithms or computer-readable instructions that are operable to recognize trends in the signature data, performing a computer analysis of a collection of the full-system signatures having one or more annotations; and
generating, from the algorithmic or computer analysis, either a prediction of when an analytical apparatus will require calibration, maintenance, component replacement, or other servicing or an identification of the root cause of a performance degradation of or failure of said analytical apparatus.

17. A method as recited in claim 16, wherein the computer analysis employs an expert system analysis technique.

18. A method as recited in claim 16, wherein the computer analysis employs deep learning using an artificial neural network.

19. A method as recited in claim 16, wherein the generating of the plurality of collections of apparatus signatures comprises providing the signatures in either JavaScript Object Notation (JSON) format or JavaScript Object Notation for Linked Data (JSON-LD) format.

20. A method as recited in claim 16, wherein the generating of the plurality of collections of apparatus signature items comprises generating signature items that employ defined categories, properties, concepts, relations and entity definitions in accordance with one or more standard ontologies.

21. A method as recited in claim 16, further comprising, prior to the transmitting of each apparatus signature items, validating said each apparatus signature item and encrypting the apparatus signature item.

22. A method as recited in claim 16, wherein the generating of the plurality of collections of apparatus signature items includes generating one or more apparatus signature items that include an alert code that notifies users or service personnel of a situation that requires immediate or urgent action.

23. A method as recited in claim 16, wherein the transmitting of a collection of apparatus signature items to the database comprises:
storing said collection of apparatus signature items at a site at which the apparatus signatures were generated;
downloading of the collection of apparatus signature items by service personnel at the time of a visit to the site; and
uploading of the collection of apparatus signature items to the database by the service personnel.
